(19) United States
(12) Patent Application Publication
(10) Pub. No.: US 2005/0060449 A1
(43) Pub. Date: Mar. 17, 2005

(54) Receiver of cordless input apparatus

(76) Inventor: Shu-Mei Chang, Chung Ho City (TW)

Correspondence Address: Yi-Wen Tseng, 509 ROOSEVELT BLVD. #D306, FALLS CHURCH, VA, 22044, US

(21) Appl. No.: 10/660,517

(22) Filed: Sep. 12, 2003

(51) Int. Cl. G06F 13/12

(52) U.S. Cl. 710/73

(57) ABSTRACT

A receiver of a cordless input apparatus, providing signal reception of wireless transmission for at least two types input devices. The receiver has a primary receiving module and a secondary receiving module. The primary receiving module is used to receive a wireless signal transmitted from one of the above input devices, while the secondary receiving module is used to receive a wireless signal from the other one of the above input devices. The primary and secondary receiving modules are electrically connected to each other by a transmission interface in a plug-in fashion. Thereby, the user can simultaneously use these two input devices to control a computer, while these two input devices can be used separately as well.

### BACKGROUND OF THE INVENTION

The present invention relates to a receiver for a cordless input apparatus and, more particularly, to signal receiver applied to provide signal reception of wireless transmission for various peripheral cordless input devices of the computer.

Keyboards and mice are necessary peripherals for operating computers. Keyboards are normally used to input texts, while the mice are typically used to control the cursor as shown on the screens. The later development of cordless keyboards and mice uses radio frequency or infrared to control signal transmission of the input of the keyboards and mice in a position remote to the computer. Further, plug-and-play and hot plugging functions of universal serial bus (USB) can be applied to the mouse of the personal computer, such that the mouse can be connected to other computers in a plug-and-play fashion allowing the user to apply it to a laptop computer outdoors.

In addition, as the mouse has to be placed on a desk or a platform for operating, it is not suitable for presentation using computer software such as Power Point in a business or company meeting. Therefore, a controller has been developed to replace the cordless mouse. Such controller is also operated by radio frequency. By controlling directional key with the thumb of the user, the cursor on the computer screen can be controlled. It is thus more convenient than the mouse to presentation.

The above cordless designs are developed to avoid affecting operation of the users. However, whether the radio frequency or the infrared transmission is adapted, a receiver is required for each input device to receive the specific signal emitted thereby. To avoid exceeding the number of slots provided by the computer by installing too many receivers therein, an integrated receiver which integrates receivers of various input devices has been developed. By the circuit integration, signals transmitted from various input devices can be transmitted to the computer via a common serial bus. The most common integrated receiver is the integrated receiver for mouse and keyboard.

The problem of the integrated receiver for various input device includes that when the user transfers only one input device from one computer to another, the integrated receiver has to be transferred together to activate the operation of such input device. Once the integrated received is removed from this computer, the other input devices become inoperable for lacking the receivers to communicate with the computer. It is thus inconvenient for use. For example, when the receivers of keyboard, mouse and controller of a computer are integrated into an common receiver, and the user wishes to apply the mouse to a laptop computer, the common receiver has to be removed from the computer to enable the mouse. In such condition, the keyboard and the controller are inoperable since the common receiver is not available. An additional set of hard wired keyboard and controller is thus required to occupy more space and cost additional expense of the user.

### BRIEF SUMMARY OF THE INVENTION

The present invention provides receiver for cordless input device, which includes two receiving modules connected together via a transmission interface to achieve the plug-and-play and hot plugging functions. Each of the receiving modules is operative to receive wireless signal transmitted from at least one input device such as keyboard, mouse or controller, respectively. According to the specific requirement, the receiving modules can be detached from each other and used independently.

The present invention further provides a receiver for cordless input devices, the receiver includes two receiving modules to provide signal reception for both portable and importable cordless input devices. The receiving modules are integrated together via a transmission interface in a plug-and-play and hot-plugging fashion. Therefore, the receiver for receiving the portable input device can be arbitrarily plugged or unplugged without affecting operation of the other input device.

The present invention further provides a receiver for receiving wireless signal of cordless input devices. The receiver includes two receiving modules connected to each other via a transmission interface in a plug-and-play and hot-plugging manner. One of the receiving modules is operative for receiving an infrared signal, while the other receiving module is operative to receive a radio frequency signal.

The receiver provided by the present invention comprises a primary receiving module and a secondary receiving module. The primary receiving module is used to receive the wireless signal transmitted by one cordless input device, while the secondary receiving module is used to receive the wireless signal transmitted from another cordless input device. The primary and secondary receiving modules are integrated with each other via a transmission interface in a plug-and-play and hot-plugging fashion.

In one embodiment, the primary receiving module is operative to receive the wireless signal transmitted from a keyboard, while the secondary receiving module is operative to receive the wireless signal transmitted from a controller.

Preferably, the primary receiving module is operative to receive an infrared signal, while the secondary receiving module is operative to receive a radio frequency signal.

### BRIEF DESCRIPTION OF THE DRAWINGS

These, as well as other features of the present invention, will become apparent upon reference to the drawings wherein:

FIG. 1 is a perspective view of a primary receiving module and a secondary receiving module unattached to each other according to the present invention; and

FIG. 2 is a perspective view showing the primary receiving module attached to the secondary receiving module;

FIG. 3 shows the operation status in a first embodiment of the present invention;

FIG. 4 shows the operation status in a second embodiment of the present invention; and

FIG. 5 shows the operation status in a third embodiment of the present invention.

### DETAILED DESCRIPTION OF THE INVENTION

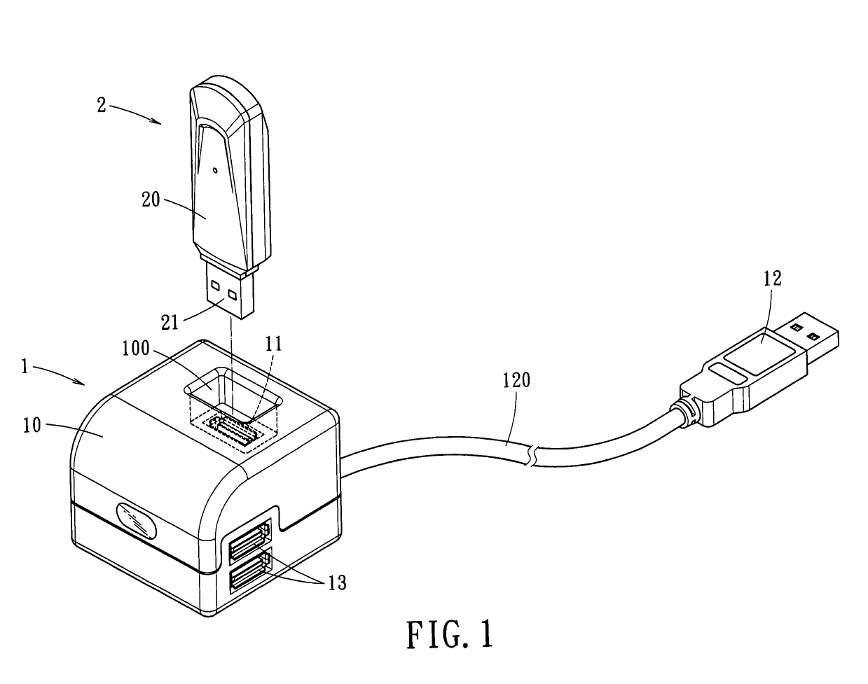

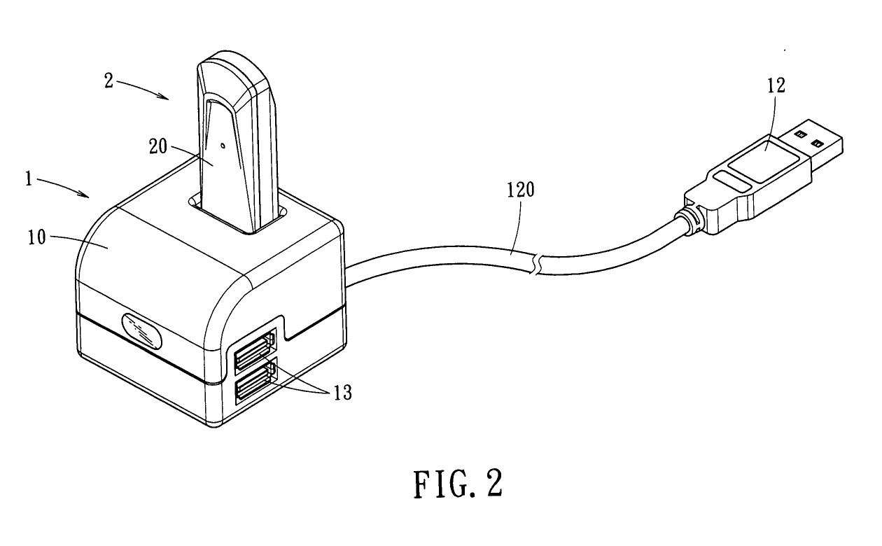

Referring to FIGS. 1 and 2, perspective views of a primary receiving module 1 and a secondary receiving module 2 detached from and attached to each other are illustrated, respectively.

The primary receiving module 1 includes an enclosure 10. The enclosure 10 includes a recessed socket 100. The secondary receiving module 2 includes a main body 20. Preferably, the main body 20 is in parallelepiped shape. The secondary receiving module 2 includes an end portion configured to match the recessed socket 100, such that the end portion can be locally plugged into the primary receiving module 1.

A transmission interface is used to interconnect the primary receiving module 1 and the secondary receiving module 2. The transmission interface includes a universal serial bus (USB) to provide the plug-and-play and hot plugging function. The transmission interface includes a slot 111 and a plug 21 matching the slot. The opening of the slot 11 is exposed underneath the recessed socket 100 and oriented towards the same direction as the opening of the recessed socket 100. The plug 21 is installed at the end of the main body 20 of the secondary receiving module 2. When the plug 21 of the secondary receiving module 2 is plugged into the slot 11 of the primary receiving module 1, an electric connection is established by the transmission interface.

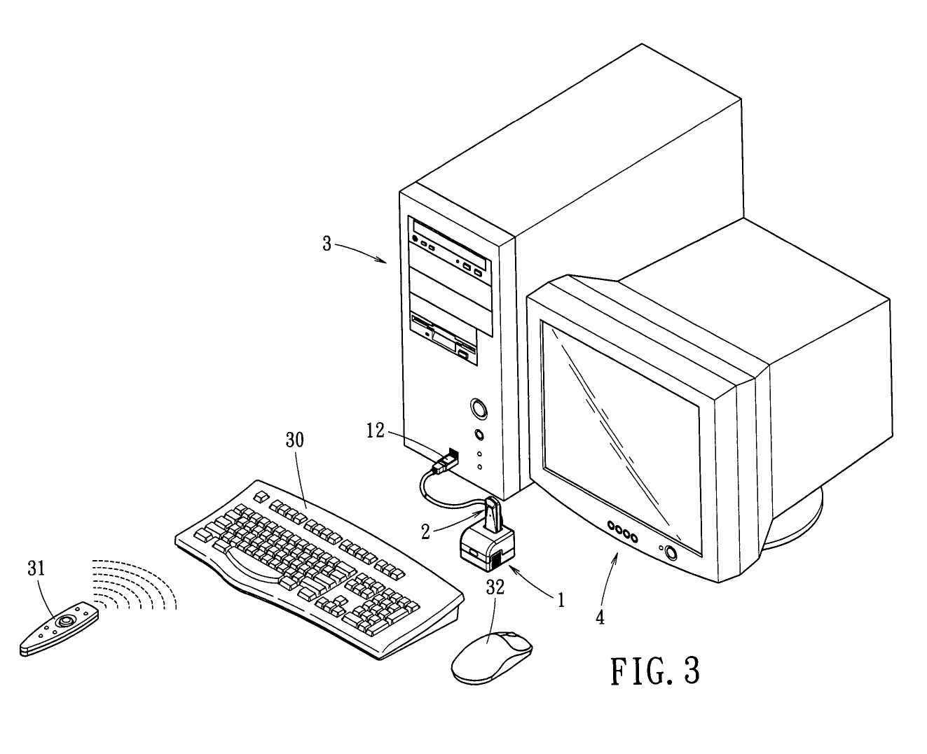

The primary receiving module 1 further comprises a transmission plug 12 plugged in the computer host 3 (as shown in FIG. 3). The transmission plug 12 is located external to the enclosure 10 of the primary receiving module 1. Alternatively, the transmission plug 12 and the enclosure 10 can be connected by a transmission line 120. The primary receiving module 1 may also comprise a transmission slot 13 formed on the enclosure 10, allowing additional input devices to be plugged in.

The above transmission plug 12 and transmission slot 13 may have the transmission specification of USB, for example.

Therefore, a receiver for a cordless input device according to the present invention is constructed.

As shown in FIG. 3, while applying the receiver as disclosed above, the transmission plug 12 is connected to the computer host 3. The primary receiving module 1 provides wireless signal transmission for at least one importable input device such as a keyboard 30. The secondary receiving module 2 is used to provide wireless signal transmission for at least one portable input device such as a controller 31. The signal reception of a mouse 32 can be integrated into either the primary or the secondary receiving module 1 or 2. In this embodiment, the receiving function of the mouse 32 is integrated into the primary receiving module 1. In other words, the user can only remove the controller 31 and the secondary receiving module 2 from the computer, while the keyboard 30, mouse 32 and the primary receiving module 1 remain connected to the computer host 3.

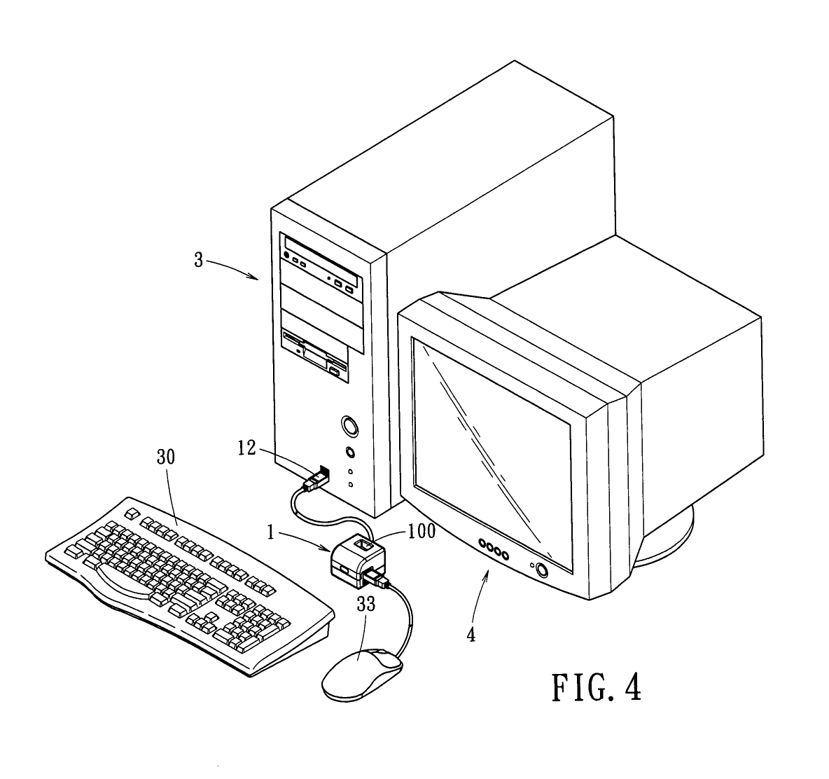

When the signal receiving function of the mouse 32 is integrated in the secondary receiving module 2, the user can remove the mouse 32, the controller 31 and the secondary receiving module 2 away from the computer host 3 for outdoors use. Thereby, the user does not require an addition mouse for a laptop computer. As shown in FIG. 4, when the user intends to use the desktop computer, only a wired or cordless mouse 33 is required to plug in the transmission slot 13 of the primary receiving slot 1.

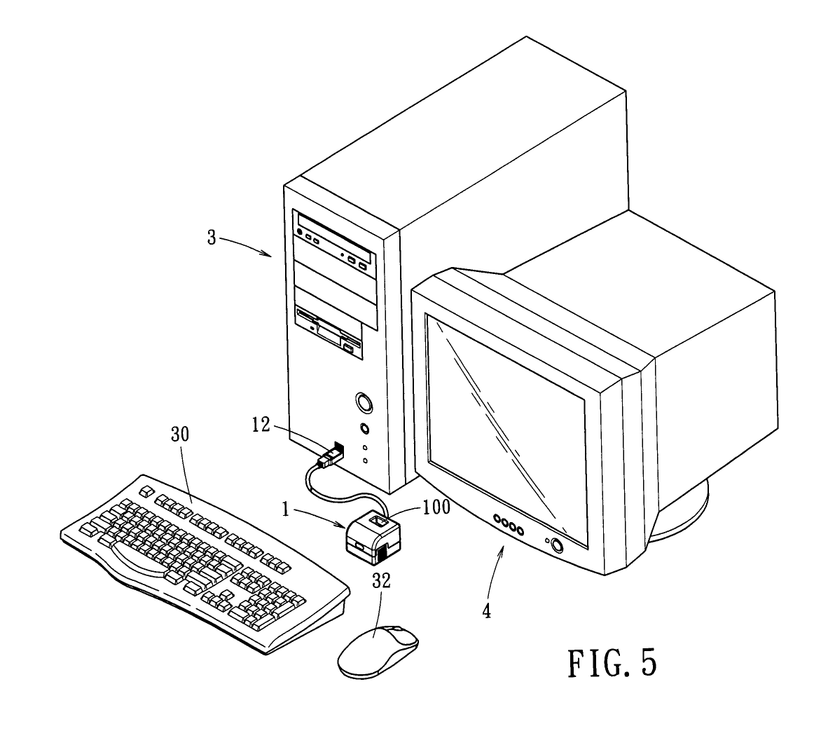

As shown in FIG. 5, infrared signal (IR) the transmission medium can also be used as a transmission medium for the primary receiving module 1, while the secondary receiving module 2 can use radio frequency (RF) to transmit signal. The primary receiving module 1 primarily receives cordless infrared signals transmitted from the keyboard 30 and the mouse 32 by because the keyboard 30 and the mouse 32 are normally placed in proximity of the computer screen 4 with exceeding the accessible range of infrared communication. As the controller 31 is often operated remote to the computer host 3 or the secondary receiving module 2, radio frequency is preferably used for communication between the computer host 3 and the controller 31.

This disclosure provides exemplary embodiments of a child safety blind. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A receiver cordless input devices, providing signal reception for wireless transmission for at least two input devices, the receiver comprising at least one primary receiving module and one second receiving module, wherein the primary receiving module is operative to receive a wireless signal transmitted from one of the input devices, and the secondary receiving module is operative to receive a wireless signal transmitted from the other input device, and the primary and secondary receiving modules use a transmission interface to connect each other in a plug-and-play and hot plugging manner.

2. The receiver according to claim 1, wherein the primary receiving module further comprises a transmission plug.

3. The receiver according to claim 2, wherein the transmission plug is connected to the primary receiving module by a transmission line.

4. The receiver according to claim 1, wherein the primary receiving module further comprises a transmission slot.

5. The receiver according to claim 1, wherein the transmission interface comprises a slot and a plug matching the slot.

6. The receiver according to claim 1, wherein the transmission interface includes a universal serial bus.

7. A receiver for cordless input devices, comprising:
a primary receiving module, operative to receive a wireless signal transmitted from a keyboard; and
a secondary receiving module, operative to receive a wireless signal transmitted from a controller;
wherein the primary and secondary receiving modules are electrically connected to each other by a plug-in transmission interface.

8. The receiver according to claim 7, wherein the primary receiving module further comprises a receiver integrated therein for receiving a wireless signal transmitted from a mouse.

9. The receiver according to claim 7, wherein the primary receiving module further comprises a transmission plug.

10. The receiver according to claim 9, wherein the transmission plug is connected to the primary receiving module by a transmission line.

11. The receiver according to claim 7, wherein the primary receiving module use infrared energy as a medium for signal transmission.

12. The receiver according to claim 7, wherein the secondary receiving module further comprises a receiver integrated therein for receiving a wireless signal transmitted from a mouse.

13. The receiver according to claim 12, wherein the primary receiving module further comprises a transmission slot.

14. The receiver according to claim 7, wherein the primary receiving module further comprises a transmission slot.

15. The receiver according to claim 7, wherein secondary receiving module use radio frequency as a medium for signal transmission.

16. The receiver according to claim 7, wherein transmission interface includes a slot and a plug matching the slot.

17. The receiver according to claim 7, wherein the transmission interface includes a universal serial bus.

18. A receiver for cordless input devices, including a primary receiving module operative to receive infrared signal and a secondary receiving module operative receive radio frequency signal, wherein the primary and secondary receiving modules are electrically connected to each other via a transmission interface.

19. The receiver according to claim 18, wherein the transmission interface comprises a slot and a plug matching the slot.

20. The receiver according to claim 18, wherein the transmission interface includes a universal serial bus.
